(19) United States
(12) Patent Application Publication
(10) Pub. No.: US 2014/0092796 A1
(43) Pub. Date: Apr. 3, 2014

(54) Method and System for Communicating with an Alarm System

(71) Applicant: Michael Gregory, Carrollton, TX (US)

(72) Inventor: Michael Gregory, Carrollton, TX (US)

(21) Appl. No.: 14/039,821

(22) Filed: Sep. 27, 2013

Related U.S. Application Data
(60) Provisional application No. 61/744,865, filed on Oct. 4, 2012.
(60) Provisional application No. 61/707,202, filed on Sep. 28, 2012.
(60) Provisional application No. 61/744,882, filed on Oct. 4, 2012.
(60) Provisional application No. 61/712,366, filed on Oct. 11, 2012.

(51) Int. Cl. H04M 11/04

(52) U.S. Cl. CPC H04M 11/04
USPC 370/310; 370/352

(57) ABSTRACT

An alarm system can provide security, fire, protection, or other alarm services for a premises, such as for a building or other property. A communication system can provide the alarm system with long-range connectivity, so the alarm system can communicate voice, data, or other information with a remote entity. In some embodiments, the communication system may utilize VoIP communications, for example flowing through an intermediary server to a central monitoring station. The alarm system can comprise an alarm panel into which the VoIP functionality is integrated, for example. In some embodiments, the alarm system can communicate with a remote entity utilizing an LTE communication data channel that may carry voice and data. The alarm system can comprise an alarm panel into which the LTE functionality is integrated, for example.

### CROSS REFERENCE TO RELATED APPLICATIONS

This application claims priority to: U.S. Provisional Patent Application No. 61/707,202 filed Sep. 28, 2012 in the name of Michael Gregory and entitled “Method and System for Advanced Communications to a Central Station; U.S. Provisional Patent Application No. 61/744,865 filed Oct. 4, 2012 in the name of Michael Gregory and entitled “Method and System for Advanced Communications to a Central Station; U.S. Provisional Patent Application No. 61/744,882 filed Oct. 4, 2012 in the name of Michael Gregory and entitled “Method and System for Advanced Broadband Alarm Signaling with Two-Way Voice Communications to a Central Station;” and U.S. Provisional Patent Application No. 61/712,366 filed Oct. 11, 2012 in the name of Michael Gregory and entitled “Method and System for VoLTE Communication of Alarm Signals. The entire contents of each of the above identified patent applications are hereby incorporated herein by reference.

### FIELD OF THE TECHNOLOGY

The present technology relates to alarm systems and more particularly to technology for providing an alarm system with long-range communication to support data and/or voice transmission.

### BACKGROUND

Conventional alarm systems often communicate with remote alarm monitoring centers, known as central monitoring stations, using audio tones over using a dialed telephone line connection. A dialer within the alarm system's panel dials into and through a standard telephone connection, colloquially known as the public switched telephone network (PSTN). Such connections are often unwieldy and inefficient.

Need is apparent for improvements in alarm system communication technology. Needs exist to provide an alarm system with an efficient capability to communicate utilizing Internet infrastructure and/or cellular infrastructure.

A capability addressing one or more such needs, or some other related deficiency in the art, would enhance alarm system communications.

### SUMMARY

An alarm system can provide security, fire, protection, or other alarm services for a premises, such as for a building or other property. A communication system can provide the alarm system with long-range connectivity so that the alarm system can communicate information to or from an entity located off of the premises. That information can comprise voice and/or data, for example.

In one aspect, the alarm system can communicate with a central monitoring station utilizing voice-over-Internet (VoIP) communications. The VoIP communications may flow through an intermediary server, for example.

In one aspect, the alarm system can comprise an alarm panel into which VoIP functionality is integrated.

In one aspect, the alarm system can communicate with a remote entity utilizing a long term evolution (LTE) communication channel. The LTE communication channel can carry voice and data, for example.

In one aspect, both alarm signals and voice are carried over a single LTE data channel.

In one aspect, the alarm system can comprise an alarm panel into which LTE functionality is integrated.

The foregoing discussion of communication with alarm systems is for illustrative purposes only. Various aspects of the present technology may be more clearly understood and appreciated from a review of the following text and by reference to the associated drawings and the claims that follow. Other aspects, systems, methods, features, advantages, and objects of the present technology will become apparent to one with skill in the art upon examination of the following drawings and text. It is intended that all such aspects, systems, methods, features, advantages, and objects are to be included within this description and covered by this application and by the appended claims of the application.

### BRIEF DESCRIPTION OF THE DRAWINGS

FIG. 1 is a functional block diagram of a system in which a VoIP channel extends from a premises to a central monitoring station to provide communication for an alarm system at the premises, in accordance with some example embodiments of the present technology.

FIG. 2 is a functional block diagram of a system in which VoIP functionality has been integrated into an alarm panel of an alarm system, in accordance with some example embodiments of the present technology.

FIG. 3 is a functional block diagram of an alarm panel having integral VoIP functionality, in accordance with some example embodiments of the present technology.

FIG. 4 is a functional block diagram of a system in which an LTE system provides an alarm system with voice and data communications, in accordance with some example embodiments of the present technology.

FIG. 5 is a functional block diagram of a system in which an alarm panel of an alarm system has integral LTE functionality to support voice and data communications, in accordance with some example embodiments of the present technology.

Many aspects of the technology can be better understood with reference to the above drawings. The elements and features shown in the drawings are not necessarily to scale, emphasis being placed upon clearly illustrating the principles of exemplary embodiments of the present technology. Moreover, certain dimensions may be exaggerated to help visually convey such principles.

### DESCRIPTION OF EXAMPLE EMBODIMENTS

Representative embodiments of the present technology relate generally to communicating with an alarm system that may provide security, fire, protection, or other alarm services for a premises, such as for a building or other property. The alarm system may further provide security for a vehicle or provide personal protection/security. Utilizing long-range communication, the alarm system can send and/or receive voice and/or data to/from a remote entity. In some embodiments, the alarm system can utilize VoIP technology for communications with a central monitoring station, either directly or by way of an intermediary server, for example. In some embodiments, VoIP functionality can be integrated into an alarm panel of the alarm system. In some embodiments, the alarm system can communicate utilizing an LTE communication channel that may carry voice and data, for example. In some embodiments, LTE functionality can be integrated into an alarm panel of the alarm system.

The present technology can be embodied in many different forms and should not be construed as limited to the embodiments set forth herein; rather, these embodiments are provided so that this disclosure will be thorough and complete, and will fully convey the scope of the technology to those having ordinary skill in the art. Furthermore, all “examples,” “embodiments,” “example embodiments,” or “exemplary embodiments” given herein are intended to be non-limiting and among others supported by representations of the present technology.

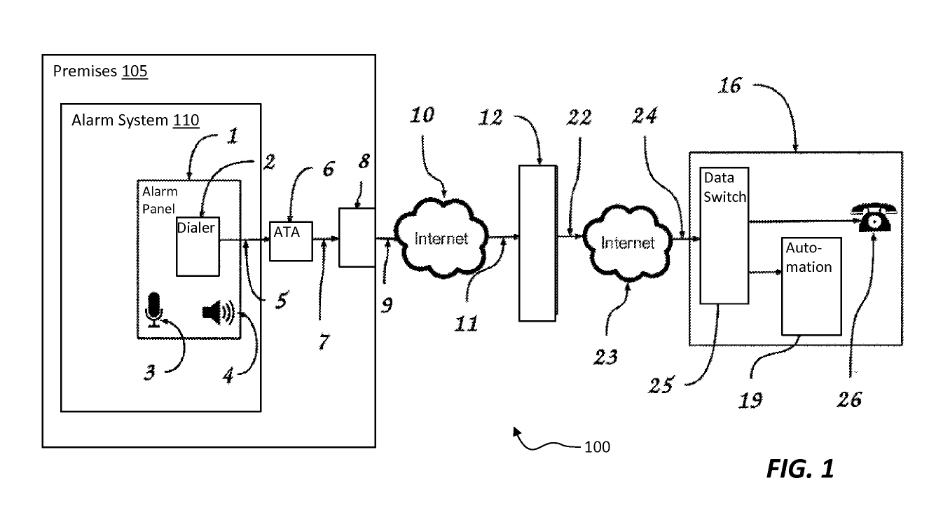

Technology for imparting alarm systems with remote communication capabilities will now be described more fully with reference to FIGS. 1-5, which describe representative embodiments of the present technology.

Turning now to FIG. 1, this figure illustrates a functional block diagram of an example system 100 in which a VoIP channel extends from a premises 105 to a central monitoring station 16 to provide communication for an alarm system 110 at the premises 105, according to some embodiments of the present technology.

In the illustrated embodiment, the alarm system 110 comprises an alarm panel 1 that communicates with the central monitoring station 16, which may be characterized as an alarm monitoring center. At the alarm panel 1, the communication utilizes audio tones of a dialed telephone line connection that is compatible with the PSTN. However, an analog telephone adapter (ATA) 6 converts the analog telephone signals into digital signals for transmission over the Internet 10, 23 with a digital protocol commonly referred to as Voice-over-Internet-Protocol (VoIP).

“Voice-over-Internet Protocol” or “VoIP” is a generic term commonly referring to the communication protocols, technologies, methodologies, and transmission techniques involved in the delivery of voice communications and multimedia sessions over Internet Protocol (IP) networks, such as (but not limited to) the Internet. Technologies within the scope of VoIP can include communication protocols, technologies, methodologies, and transmission techniques such as IP telephony, Internet telephony, voice over broadband (VoBB), broadband telephony, IP communications, broadband phone, and Voice over LTE (VoLTE), for example.

During an occurrence of an event report, a dialer 2 in the alarm panel 1 of the alarm system 110 dials a designated telephone number using audio tones over an associated analog telephone line 5. The event report could comprise a break in, a smoke detector sensing a level of smoke indicative of a fire, or another event that triggers an alarm or warrants reporting.

Opposite the dialer 2, the telephone line 5 is connected to the analog telephone adapter 6. The analog telephone adapter 6 receives the dialed telephone number from the alarm panel 1 and converts the analog telephone signals into digital signals for transmission over the Internet 10. Connection between the analog telephone adapter 6 and the Internet 10 may, optionally, be through a data router 8. The data router 8 is optional since the analog telephone adapter 6 may connect directly to the Internet, for example. While the element denoted “8” will be referenced below as “the data router 8” that element may be a modem or may comprise a modem. Typically, communications between the analog telephone adapter 6 and the Internet 10 may be via VoIP, which may be carried utilizing Ethernet and/or local area network (LAN) technology.

When the analog telephone adapter 6 initiates a communications connection, the connection can extend in a digital format all the way from the analog telephone adapter 6 to the central monitoring station 16. In some example embodiments, VoIP formatted information can flow bidirectionally between the analog telephone adapter 6 and the central monitoring station 16. An intermediary server 12, for example, can maintain the VoIP formatting while processing communications, including while varying one or more fields of the VoIP format, readdressing, changing headers, adjusting protocol specifics, etc.

The intermediary server 12 may also be characterized as an intermediate server and in some embodiments may comprise a communications gateway. In the illustrated embodiment, the intermediary server 12 is offsite of the premises 105. In a representative embodiment, the intermediary server 12 additionally serves other alarm systems at other premises. Accordingly, the illustrated intermediary server 12 can provide a gateway for varied security systems that may be geographically dispersed. In some example embodiments, the intermediary server 12 may comprise or be characterized as a middleware server. A representative server or gateway is disclosed in the Applicant's U.S. patent application Ser. No. 13/413,333 (filed Mar. 6, 2012 and entitled “Delivery of Alarm System Event Data and Audio Over Hybrid Networks”) and Ser. No. 13/438,941 (filed Apr. 4, 2012 and entitled “Delivery of Alarm System Event Data and Audio”). The content and complete and entire disclosure made by each of these identified patent applications are hereby fully incorporated herein by reference.

The intermediary server 12, in turn, communicates with the central monitoring station 16 (as discussed above), which may be remote from the intermediary server 12. However in some example embodiments, the intermediary server 12 is collocated with the central monitoring station 16. Thus, the central monitoring station 16 may comprise one or more intermediary servers 12 that provide connectivity to various alarm systems. The central monitoring station 12 typically provides monitoring services that may include human operators interacting with alarm systems and users and dispatching emergency personnel when conditions warrant.

In the illustrated embodiment of FIG. 1, the digital communication connection extends through the data link 7, the data router 8, and the data link 9 that leads to the Internet 10. The Internet 10 carries the digital connection to the intermediary server 12. In an example embodiment, the analog telephone adapter 6 and/or the router 8 addresses information packets of the VoIP communications to the intermediary server 12.

In some example embodiments, the intermediary server 12 analyzes the received signals for account verification and routing purposes, for example in accordance with typical practices of the alarm monitoring service industry. The intermediary server 12 directs the digital connection to the central monitoring station 16 that is associated with the verified account of the alarm system 110 that originated the event report. For example, the intermediary server 12 may readdress the packets to the central monitoring station 16, so that digital signals flow over digital networking links 22 and 24 via the Internet 23. The communication path between the intermediary server 12 and the central monitoring station 16 can be implemented by an IP network capable of communicating VoIP, IP telephony, Internet telephony, VoBB, broadband telephony, IP communications, broadband phone, or VoLTE, for example.

Upon communication receipt at the central monitoring station 16, a data switch 25 and an associated automation module 19 route information within the station 16, for example activating displays and alerts as appropriate. In some example embodiments, the IP connection is terminated over the network link 24 on the data switch 25 located within the central monitoring station 16. In some example embodiments, the central monitoring station 16 utilizes an internal IP network infrastructure, so that IP packets are routed throughout the station 16.

For example, event data can be forwarded by data switch 25 and received and processed by the automation module 19 that activates displays and alerts. Depending upon predetermined options associated with the account of the alarm panel 1 that originated the event, the event data may further trigger interconnection of a VoIP telephone call between the data switch 25 and the VoIP telephone equipment 26, to enable a human operator of the central monitoring station 16 to communicate with the speaker 4 and microphone 3 of the alarm panel 1. Accordingly, the type of alarm event may be identified so that the operator or other personnel may act on it, for example to dispatch emergency service personnel.

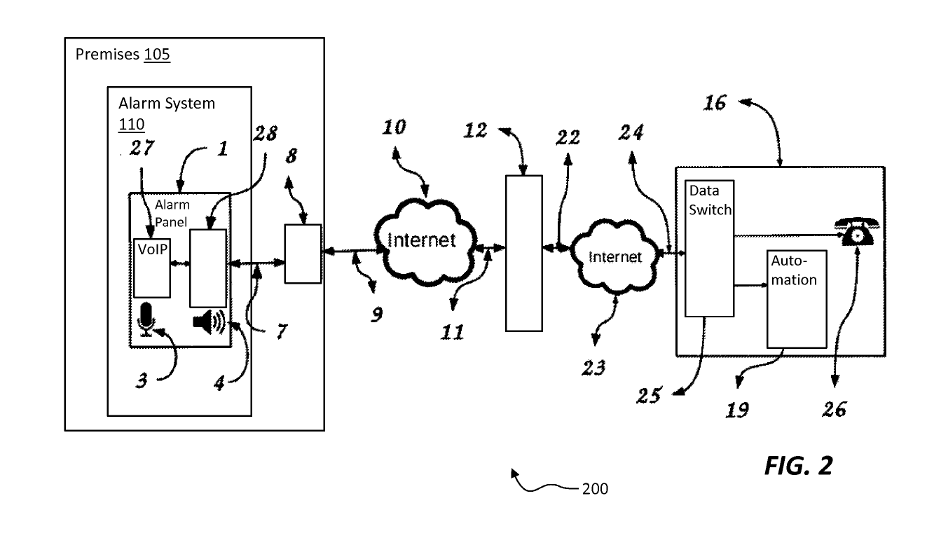

Turning now to FIG. 2, this figure illustrates a functional block diagram of an example system 200 in which VoIP functionality has been integrated into an alarm panel 1 of an alarm system 110, according to some embodiments of the present technology. The term “integrated,” as used herein, generally refers to united, combined, brought together, included, or joined. The integrated VoIP functionality of the system 200 can be implemented via mounting electronic components on a common circuit board (for example where a mother board supports discrete circuit components, integrated circuits or chips, and daughter boards), via housing various elements in or on a common enclosure, or via one or more other appropriate integration approaches, for example.

In some example embodiments, the portions of the system 200 illustrated in FIG. 2 that are beyond the premises 105 function in accordance with the portions of the system 100 illustrated in FIG. 1 that are beyond the premises 105, as described above. In some example embodiments, the portions of the system 200 spanning from the router 8 to the central monitoring station 16, as illustrated in FIG. 2, duplicate the portions of the system 100 spanning from the router 8 to the central monitoring station 16 illustrated in FIG. 1 and discussed above.

In the illustrated embodiment of FIG. 2, the alarm panel 1 achieves integrated VoIP functionality via a VoIP module 27 and a network module 28. The VoIP module 27 can comprise one or more VoIP processor integrated circuits or modules, as commercially available from AudioCodes Limited or from Palmmicro Communications Inc., for example. The VoIP module 27 in combination with the speaker 4 and the microphone 3 can comprise an IP telephone in some example embodiments.

During an occurrence of an event report, the alarm panel 1 establishes a digital VoIP communication session by dialing a predetermined telephone number using the networking module 28, which can provide a digital Ethernet connection to the Internet 10 in a representative embodiment. The networking module 28 can comprise a module or integrated circuit as marketed by Telit Communications S.p.A. EMEA (Trieste, Italy) under the trade identifier GE864-QUAD GSM/GPRS Quad-Band cellular module or as marketed by HMS Networks AB under the trade identifier AnyBus EtherNet/IP. In some example embodiments, the networking module 28 can be implemented as (or otherwise comprise) software code (that is, computer executed instructions), for example.

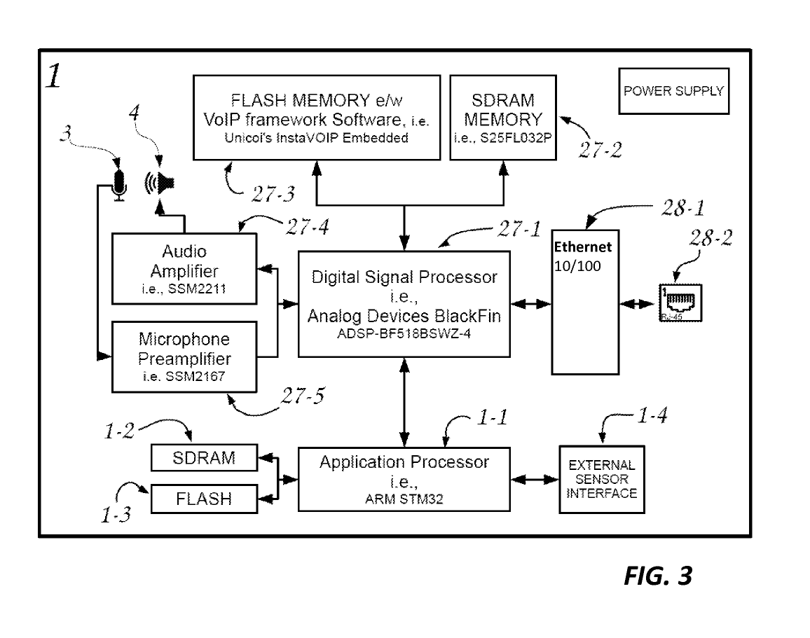

FIG. 3 and the associated discussion below provide additional implementation options and details of example embodiments for integrating VoIP functionality into the alarm panel 1.

In the illustrated example embodiment of FIG. 2, the networking module 28 of the alarm panel 1 connects to the Internet 10 via a first data link 7 that leads to the data router 8 and via a second data link 9 that leads from the data router 8 to the Internet 10. In some embodiments, the networking module 28 may connect directly to the Internet 10, for example using integrated routing technology. Furthermore, the networking technology utilized to connect the networking module 28, the data router 8, and the Internet may be wired or wireless in nature and may comprise a local area network, for example.

In representative operation, the VoIP module 27 initiates a communication connection over the data link 7, and, optionally, through the data router 8 and the data link 9, to and through the Internet 10 and the data link 11 to digital processing equipment within the intermediary server 12.

Typically, communications between the VoIP module 27 and the Internet 10 are via VoIP. Suitable communication protocols, technologies, methodologies and transmission techniques may include IP telephony, Internet telephony, VoBB, broadband telephony, IP communications, broadband phone, and/or VoLTE, for example.

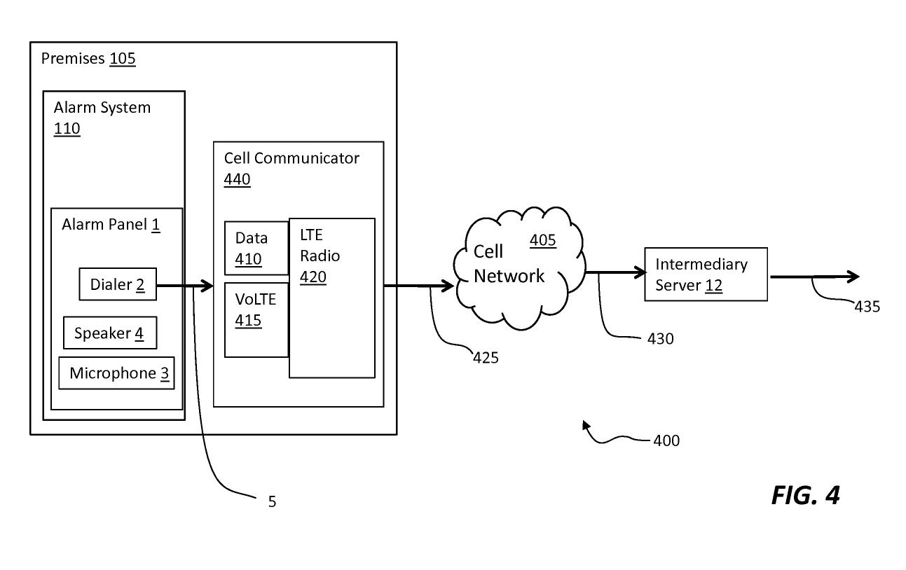

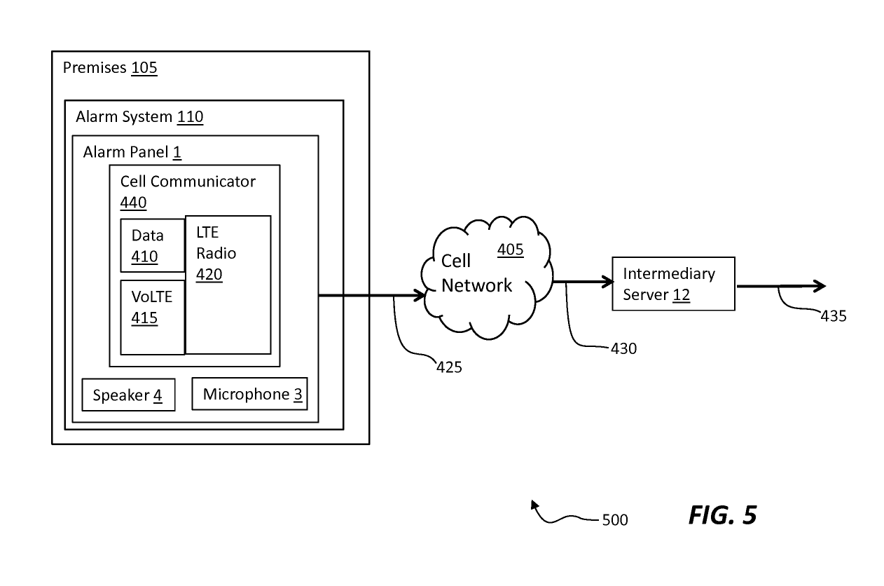

In some embodiments, a VoIP communication of alarm signals can be carried via a 2G, 3G, 4G, or other cellular, wi-fi, digital enhanced cordless telecommunications (DECT), or other wireless transport mechanism, for example. FIGS. 4 and 5 (which will be discussed in further detail below, in turn) provide representative examples of VoLTE implementations. In a representative form of such an implementation, VoIP functionality can be connected to a cellular mobile radiotelephone module (not shown in FIG. 3) of the alarm panel 1, and communication of alarm signals (for example carrying event data or status data) can be completed on a cellular data channel using VoLTE communication. A radiotelephone module of the alarm panel 1 can transmit the VoLTE communication for processing by the intermediary server 12. The adoption of VoLTE as a communications transport can provide an end-to-end IP connection with VoIP carried exclusively by a cellular data channel (rather than a cellular voice channel), for example.

Referring to FIG. 2, the intermediary server 12 analyzes the received signals for account verification and routing purposes. Utilizing industry standard Internet Protocol, the intermediary server 12 transmits event data to the central monitoring station 16 associated with the verified account of the alarm system 110, for example as discussed above with reference to FIG. 1. The communication path between the intermediary server 12 and the central monitoring station 16 can be implemented via an IP network capable of communicating IP telephony, Internet telephony, VoBB, broadband telephony, IP communications, broadband phone, VoLTE, or other appropriate technology. A VoIP communication of event data can be carried via a 2G, 3G, 4G, or other cellular, wi-fi, DECT, or other wireless transport mechanism, for example.

The IP connection may terminate over network link 24 on the data switch 25 within the central monitoring station 16. The event data received from the intermediary server 12 is forwarded by the data switch 25 and received and processed by the automation module 19 that may, in response, activate displays and alerts. Additionally, the automation module 19 may (depending upon predetermined options associated with the account of the alarm system 110 that originated the event) cause an interconnection of the VoIP telephone call between the data switch 25 and a VoIP telephone module 26 within the central monitoring station 16. Accordingly, an operator at the central station 16 may communicate with the speaker 4 and microphone 3 of the alarm panel 1, for example to speak with a person at the premises 105.

Turning now to FIG. 3, this figure illustrates a functional block diagram of an example alarm panel 1 having integral VoIP functionality, according to some embodiments of the present technology. The alarm panel 1 illustrated in FIG. 3 can be an example embodiment of the alarm panel 1 illustrated in FIG. 2 and will be discussed in such a representative context, without limitation.

As discussed in further detail below, the VoIP module 27 comprises a digital signal processor (DSP) 27-1, a random access memory 27-2, a flash memory 27-3, an audio amplifier 27-4, and a microphone amplifier 27-5. And, the network interface 28 comprises an Ethernet integrated circuit 28-1 and a physical interface or port 28-2.

In the embodiment of FIG. 3, the alarm panel 1 incorporates the digital signal processor 27-1 that can comprise a limited instruction set fast microprocessor suitable for signal processing. In one example embodiment, the digital signal processor 27-1 may be implemented as the embedded processor product marketed by Analog Devices Inc. under the registered trademark “BLACKFIN,” but other appropriate digital signal processors may be alternatively used.

The digital signal processor 27-1 utilizes associated program and data storage in the form of the FLASH memory 27-3 and the random access memory (RAM) 27-2 for program execution. The FLASH memory 27-3 stores program software and associated data to support functionality of the VoIP module 27. An example embodiment can utilize the commercially available product that Unicoi Systems, Inc. markets under the registered trade identifier “INSTAVOIP,” but other appropriate software suites may be alternatively used.

Operating the VoIP software suite in the digital signal processor 27-1 supports comprehensive VoIP functionality of VoIP module 27 once connected with the microphone 3, the speaker 4, and the network interface 28. The illustrated network interface 28 is comprised of an Ethernet integrated circuit 28-1 and physical interface or port 28-2. Integrated circuit amplifiers 27-4 and 27-5 provide amplification for the microphone 3 and speaker 4 at the interface with the digital signal processor 27-1.

In the example embodiment of FIG. 3, the alarm panel 1 is provided with an additional embedded application processor 1-1 for typical alarm functionality associated with interfacing with alarm sensors via the external sensor interface 1-4. However, in some embodiments, the functionality of the application processor 1-1 can be incorporated into the digital signal processor 27-1.

For example, the above described embodiment of the digital signal processor 27-1 may offer excess processing capability for implementing alarming functions. Further, the above described embodiment of the embedded software executed by the digital signal processor 27-1 can include a real-time multitasking operating system (OS) sufficient to incorporate the security alarm portion of the alarm panel 1 as a process or task executing quasi-simultaneously within the digital signal processor 27-1. Thus, it is feasible to either utilize a secondary processor for the alarm system function or to implement the alarm system function as a process within the digital signal processor 27-1.

The external sensor interface 1-4 constitutes inputs and outputs to external sensors and terminates either on application processor 1-1 or digital signal processor 27-1, depending on the chosen configuration.

In some example embodiments, the alarm panel 1 illustrated in FIG. 3 can be implemented as a single, monolithic printed circuit board. The term “monolithic,” as used herein, generally refers to something that is housed in a common enclosure or that is others configured as a single unit. In some example embodiments, the illustrated alarm panel 1 can be housed in a common enclosure, for example.

Turning now to FIG. 4, this figure illustrates a functional block diagram of an example system 400 in which an LTE system provides an alarm system 110 with voice and data communications, according to some embodiments of the present technology. In the system 400, the alarm system 110, its alarm panel 1, and the associated telephone line 5 can be equivalent to the alarm system 110, the alarm panel 1, and the telephone line 5 illustrated in FIG. 1 and discussed above, and thus the foregoing discussion of those elements applies to FIG. 4.

However, in the system 400 of FIG. 4, the telephone line 5 connects to a cell communicator 440 that communicates with the intermediary server 12 over the cellular network 405 using VoLTE communication on wireless paths 425 and 430. The cellular communicator 440 comprises an LTE radio 420 to communicate alarm data and voice on one LTE data channel. To integrate data and voice communication, the cell communicator 440 comprises a data module 410 for handling alarm data and a VoLTE module 415 for handling voice, with the LTE radio 420 aggregating the voice and the data. Accordingly, the cell communicator 440 provides functionality of a multi-band LTE device that integrates an LTE radio for data and a 2G/3G radio for voice calls. Additionally, in some example embodiments, the cell communicator 440 may function and provide service when 2G/3G networks are sunset and only 4G service is available in certain areas.

The intermediary server 12 communicates with the central monitoring station 16 (shown in FIG. 1 and discussed above) via the communication path 435 which may utilize wireless or wireline communication. In some example embodiments, the communication path 435 comprises the PSTN. In some embodiments, the communication path comprises the Internet or other packet switched network, for example.

Turning now to FIG. 5, this figure illustrates a functional block diagram of a system 500 in which an alarm panel 1 of an alarm system 110 has integral LTE functionality to support voice and data communications, according to some embodiments of the present technology. Accordingly, the alarm panel 1 can communicate directly and wirelessly with the intermediary server 12 via the cellular network 405.

Similar to how the system 200 of FIG. 2 included an alarm panel 1 having integrated VoIP functionality, the system 500 of FIG. 5 utilizes an alarm panel 1 with integrated LTE technology. In some embodiments, the illustrated elements of the alarm panel 1 are mounted on or to a common circuit board or other substrate, for example. In some embodiments, the illustrated elements of the alarm panel 1 are enclosed in or otherwise fixed to a common housing, for example.

Technology for alarm system communication has been disclosed, including various embodiments as follows without limitation.

Example embodiments of an alarm panel for a security system for a premises are disclosed. The example alarm panel can comprise: a sensor interface comprising a plurality of inputs configured for connecting to alarm detectors disposed at the premises, in order to receive signals produced by the alarm detectors conveying alarm information; a voice system, comprising a microphone operable to receive first voice sounds and a speaker operable to emit second voice sounds; a processor that is electrically connected to the sensor interface to receive the conveyed alarm information and that is electrically connected to the voice system; an Ethernet interface, operable to provide the alarm panel with connectivity to a router; and a communication system that is electrically connected to the processor and to the Ethernet interface, the communication system operable to provide the alarm panel with data communication and VoIP communication via the Ethernet interface, wherein the processor is operable to send the conveyed alarm information to the Ethernet interface using the data communication and to establish a two-way voice session extending between the voice system and the Ethernet interface based on an evaluation of the conveyed alarm information, the two-way voice session using the VoIP communication.

In some example embodiments of this alarm panel, the processor is further operable to perform the evaluation of the conveyed alarm information to determine whether to establish the two-way voice session.

In some example embodiments of this alarm panel, the evaluation of the conveyed alarm information occurs remote from the premises, and the processor is operable to establish the two-way voice session based on a result of the evaluation received through the Ethernet interface.

In some example embodiments of this alarm panel, the alarm panel comprises the router.

In some example embodiments of this alarm panel, the alarm panel comprises the router and a modem.

In some example embodiments of this alarm panel, the alarm panel comprises the router and a cellular modem.

In some example embodiments of this alarm panel, the router is separate from the alarm panel, and the Ethernet interface comprises a port for connecting to the router via a local area network.

In some example embodiments of this alarm panel, the alarm panel further comprises an enclosure to which the sensor interface, the voice system, the processor, and the Ethernet interface are attached.

In some example embodiments of this alarm panel, the sensor interface, the processor, the Ethernet interface, and at least a circuit of the voice system are mounted to a common circuit board.

In some example embodiments of this alarm panel, the VoIP communication extends from the alarm panel to a central monitoring station via the Internet.

In some example embodiments of this alarm panel, the VoIP communication extends from the alarm panel to an intermediary server.

In some example embodiments of this alarm panel, the router interfaces with a cellular network.

In some example embodiments of this alarm panel, the router connects to the Internet via a cellular modem using data and VoLTE communication.

In some example embodiments of this alarm panel, the data communication and the VoIP communication extend from the alarm panel to an intermediary server, and the intermediary server communicates with a central monitoring station via public switched telephone network (PSTN) communication.

In some example embodiments of this alarm panel, the data communication and the VoIP communication extend from the alarm panel to an intermediary server, and the intermediary server communicates with a central monitoring station via the Internet based on data and VoIP communications.

Example embodiments of an alarm network are also disclosed. The alarm network can comprise: a communication module that is configured for installing in an alarm panel and that is operable to produce first VoIP communications addressed to an intermediary server; and the intermediary server that is operable to receive the first VoIP communications and to produce second VoIP communications from the first VoIP communications, the second VoIP communications addressed to a central monitoring station.

In some example embodiments of this alarm network, the intermediary server is further operable: to receive third VoIP communications from the central monitoring station; and to produce fourth VoIP communications from the third VoIP communications, the fourth VoIP communications addressed to the communications module.

In some example embodiments of this alarm network, the intermediary server is further operable to communicate with other, geographically dispersed communications modules via VoIP communication.

In some example embodiments of this alarm network, the communication module comprises a wireless router; and the central monitoring station comprises a data switch for processing the second VoIP communications and establishing a two-way voice session between an operator at the central monitoring station and the alarm panel and an automation module for controlling the data switch.

In some example embodiments of this alarm network, the intermediary server comprises a communications gateway for providing Internet connectivity between the central monitoring station and a network of communications modules, each associated with a respective alarm panel.

Example embodiments of a system are also disclosed. The system can comprise a communication module. The communication module can comprise: a long term evolution (LTE) radio configured to transmit alarm data and two-way voice communications over a common communication channel that provides cellular connectivity between an alarm system and an intermediary sever; a data module that is operably coupled to the LTE radio and that is operable to process the alarm data; and a voice over LTE (VoLTE) module that is operably coupled to the LTE radio and that is operable to process the two-way voice communications.

In some example embodiments of this system, an alarm panel comprises the communication module.

In some example embodiments of this system, the communication module further comprises an analog port that is configured to connect to a dialer of an alarm panel that has an associated microphone and a speaker, and the VoLTE module is connected between the LTE radio and the analog port.

In some example embodiments of this system, the intermediary server connects to a central monitoring station via an analog dialup connection.

In some example embodiments of this system, the intermediary server connects to a central monitoring station via a VoIP connection.

In some example embodiments of this system, the communication module comprises an analog telephone adapter.

In some example embodiments of this system, the system comprises an alarm panel that comprises: a sensor interface; a voice system; the communication module; and a housing. The can comprise a plurality of inputs configured for connecting to alarm detectors disposed at a premises, in order to receive signals produced by the alarm detectors conveying alarm information. The voice system can comprise a microphone operable to receive first voice sounds and a speaker operable to emit second voice sounds. The housing can enclose at least a portion of the communication module, at least a portion of the sensor interface, and at least a portion of the voice system.

Example embodiments are also disclosed of a system that comprises: an alarm system disposed at a premises; an intermediary server; a central monitoring station; and one or more VoIP communication channels that extend from the premises to the intermediary server and from the intermediary server to the central monitoring station.

From the description, it will be appreciated that embodiments of the present technology overcome limitations of the prior art. Those skilled in the art will appreciate that the present technology is not limited to any specifically discussed application or implementation and that the embodiments described herein are illustrative and not restrictive. From the description of the exemplary embodiments, equivalents of the elements shown therein will suggest themselves to those skilled in the art, and ways of constructing other embodiments of the present technology will appear to practitioners of the art.

What is claimed is:

1. An alarm panel for a security system for a premises, the alarm panel comprising:
a sensor interface comprising a plurality of inputs configured for connecting to alarm detectors disposed at the premises, in order to receive signals produced by the alarm detectors conveying alarm information;
a voice system, comprising:
a microphone operable to receive first voice sounds; and
a speaker operable to emit second voice sounds;
a processor that is electrically connected to the sensor interface to receive the conveyed alarm information and that is electrically connected to the voice system;
an Ethernet interface, operable to provide the alarm panel with connectivity to a router; and
a communication system that is electrically connected to the processor and to the Ethernet interface, the communication system operable to provide the alarm panel with data communication and VoIP communication via the Ethernet interface,
wherein the processor is operable to:
send the conveyed alarm information to the Ethernet interface using the data communication; and
establish a two-way voice session extending between the voice system and the Ethernet interface based on an evaluation of the conveyed alarm information, the two-way voice session using the VoIP communication.

2. The alarm panel of claim 1, wherein the processor is further operable to perform the evaluation of the conveyed alarm information to determine whether to establish the two-way voice session.

3. The alarm panel of claim 1, wherein the evaluation of the conveyed alarm information occurs remote from the premises, and
wherein the processor is operable to establish the two-way voice session based on a result of the evaluation received through the Ethernet interface.

4. The alarm panel of claim 1, wherein the alarm panel comprises the router.

5. The alarm panel of claim 4, wherein the alarm panel further comprises a modem.

6. The alarm panel of claim 5, wherein the modem comprises a cellular modem.

7. The alarm panel of claim 1, wherein the router is separate from the alarm panel, and
wherein the Ethernet interface comprises a wireless transceiver for connecting to the router or a modem via a wireless connection.

8. The alarm panel of claim 1, further comprising an enclosure to which the sensor interface, the voice system, the processor, and the Ethernet interface are attached.

9. The alarm panel of claim 1, wherein the sensor interface, the processor, the Ethernet interface, and at least a circuit of the voice system are mounted to a common circuit board.

10. The alarm panel of claim 1, wherein the VoIP communication extends from the alarm panel to a central monitoring station via the Internet.

11. The alarm panel of claim 1, wherein the VoIP communication extends from the alarm panel to an intermediary server.

12. The alarm panel of claim 1, wherein the router interfaces with a cellular network.

13. The alarm panel of claim 1, wherein the router connects to the Internet via a cellular modem using data and VoLTE communication.

14. The alarm panel of claim 1, wherein the data communication and the VoIP communication extend from the alarm panel to an intermediary server, and
wherein the intermediary server communicates with a central monitoring station via public switched telephone network (PSTN) communication.

15. The alarm panel of claim 1, wherein the data communication and the VoIP communication extend from the alarm panel to an intermediary server, and
wherein the intermediary server communicates with a central monitoring station via the Internet based on data and VoIP communications.

16. An alarm network comprising:
a communication module that is configured for installing in an alarm panel and that is operable to produce first VoIP communications addressed to an intermediary server; and
the intermediary server that is operable to receive the first VoIP communications and to produce second VoIP communications from the first VoIP communications, the second VoIP communications addressed to a central monitoring station.

17. The alarm network of claim 16, wherein the intermediary server is further operable:
to receive third VoIP communications from the central monitoring station; and
to produce fourth VoIP communications from the third VoIP communications, the fourth VoIP communications addressed to the communications module.

18. The alarm network of claim 16, wherein the intermediary server is further operable to communicate with other, geographically dispersed communications modules via VoIP communication.

19. The alarm network of claim 16, wherein the communication module comprises a wireless receiver to communicate with a wireless internet router or modem.

20. The alarm network of claim 16, wherein the central monitoring station comprises:
a data switch for processing the second VoIP communications and establishing a two-way voice session between an operator at the central monitoring station and the alarm panel; and
an automation module for controlling the data switch.

21. The alarm network of claim 16, wherein the intermediary server comprises a communications gateway for providing Internet connectivity between the central monitoring station and a network of communications modules, each associated with a respective alarm panel.

22. A system comprising:
a communication module comprising:
a long term evolution (LTE) radio configured to transmit alarm data and two-way voice communications over a common data communication channel that provides cellular connectivity between an alarm system and an intermediary sever;
a data module that is operably coupled to the LTE radio and that is operable to process the alarm data; and
a voice over LTE (VoLTE) module that is operably coupled to the LTE radio and that is operable to process the two-way voice communications.

23. The system of claim 22, wherein an alarm panel comprises the communication module.

24. The system of claim 22, wherein the communication module further comprises an analog port that is configured to connect to a dialer of an alarm panel that has an associated microphone and a speaker, and
wherein the VoLTE module is connected between the LTE radio and the analog port.

25. The system of claim 22, wherein the intermediary server connects to a central monitoring station via an analog dialup connection.

26. The system of claim 22, wherein the intermediary server connects to a central monitoring station via a VoIP connection.

27. The system of claim 22, wherein the communication module comprises an analog telephone adapter.

28. The system of claim 22, wherein the system comprises an alarm panel that comprises:
a sensor interface comprising a plurality of inputs configured for connecting to alarm detectors disposed at a premises, in order to receive signals produced by the alarm detectors conveying alarm information;
a voice system, comprising:
a microphone operable to receive first voice sounds; and
a speaker operable to emit second voice sounds;
the communication module; and
a housing enclosing:
at least a portion of the communication module;
at least a portion of the sensor interface; and
at least a portion of the voice system.

29. A system comprising:
an alarm system disposed at a premises;
an intermediary server;
a central monitoring station; and
one or more VoIP communication channels that extend from the premises to the intermediary server and from the intermediary server to the central monitoring station.

30. A system comprising:
an alarm system disposed at a premises;
a central monitoring station that comprises an intermediary server; and
one or more VoIP communication channels that extend from the premises to the intermediary server.

31. The system of claim 30, wherein the intermediary server is disposed in the central monitoring station.

32. The system of claim 30, wherein the central monitoring station comprises communication infrastructure, and
wherein the intermediary server is integrated with the communication infrastructure.

33. A method comprising the steps of:
providing an LTE data channel; and
transmitting alarm signals and voice over the LTE data channel.
